(19) United States
(12) Patent Application Publication
(10) Pub. No.: US 2026/0208687 A1
(43) Pub. Date: Jul. 23, 2026

(54) METHOD FOR PRODUCING AN AIRBAG MODULE OR BELT STRAP FOR A SAFETY SYSTEM IN VEHICLES

(71) Applicant: ZF AUTOMOTIVE GERMANY GMBH, Alfdorf (DE)

(72) Inventors: Senra OEZKAN, Remshalden (DE); Susanne KAISER, Lorch (DE); Sebastian WIENHOLD, Anzing (DE)

(21) Appl. No.: 18/859,708

(22) PCT Filed: Apr. 20, 2023
(86) PCT No.: PCT/EP2023/060269

§ 371 Date: Oct. 24, 2024

(30) Foreign Application Priority Data
Apr. 25, 2022 (DE) 10 2022 109 856.7

(51) Int. Cl. B60R 21/235; C08G 63/183; C08G 63/78; C08G 69/28; C08J 11/06; D03D 15/283; D03D 15/573

(52) U.S. Cl. CPC B60R 21/235; C08G 63/183; C08G 63/78; C08G 69/28; C08J 11/06; D03D 15/283; D03D 15/573; B60R 2021/23509; B60R 2021/23542; B60R 2021/23576; C08J 2367/02; D10B 2331/02; D10B 2331/04; D10B 2505/124

(57) ABSTRACT

The invention relates to a method of manufacturing an airbag module for a safety device in vehicles, the airbag module comprising a module housing, an airbag introduced to the module housing and a gas generator connected to the module housing, the method comprising the steps of: providing a multi-filament yarn by melt spinning; weaving the multi-filament yarn to form a fabric and optionally brightening the fabric; cutting the fabric into wall parts of an airbag and sewing the wall parts to form the airbag with a gas inlet opening; introducing the airbag with the gas inlet opening into the module housing, and coupling the gas inlet opening to the gas generator to form the airbag module, wherein the multi-filament yarn is made at least of a thermoplastic polymer that is produced partly or completely using recycled or renewable raw materials. Further, the invention relates to a method of manufacturing a webbing.

### TECHNICAL FIELD

The invention relates to a method of manufacturing an airbag module or a webbing for a safety system in vehicles.

### BACKGROUND

An airbag module is an element of safety systems which in the meantime has been provided frequently in vehicles and by which a vehicle occupant or third persons are intended to be protected against injuries in the case of various types of accidents. This is done by an appropriate trigger sensor system activating, in a case of need, a gas generator that provides compressed gas which is introduced into the airbag. Starting from its folded idle position, the airbag deploys to provide, for example, a restraining effect for a vehicle occupant.

Belt tensioner modules which include a gas generator or a different actuator that is actuated in a case of accident and acts upon the seatbelt operate in a similar way to eliminate the so-called belt slack in the seatbelt. This ensures that the seatbelt is closely adjacent to the body of a vehicle occupant in the event of an accident of the vehicle and that the vehicle occupant is involved in the vehicle deceleration as early as possible.

For manufacturing the seatbelt systems, a number of plastic materials are used. The previously used plastic materials are petroleum-based, however, and cause partially considerable greenhouse gas emissions along their value chain. The CO2 released by the value chain contributes to the greenhouse effect that is responsible for the global warming. Those greenhouse gas emissions are quantified by the Product Carbon Footprint (PCF) that is established and defined by the DIN EN ISO 14067 and DIN EN ISO 14064-3 standards. Product Carbon Footprint (PCF) stands for those greenhouse gas emissions which result from the manufacture of products throughout their use to the disposal. Therefore, it is the goal to improve the environmentally friendly handling of plastic materials even in the field of safety-relevant components and to reduce the PCF.

The manufacture of biobased or recycled plastics per se is already known. A use of biobased or recycled plastics in safety devices for vehicles has not yet become accepted with respect to the required reliability of the components.

### SUMMARY

Thus, the object underlying the invention is to provide the manufacture of safety systems on the basis of sustainable raw materials.

This object is achieved by a method of manufacturing an airbag module according to claim 1 as well as a method of manufacturing webbing for a safety system in vehicles according to claim 2.

Advantageous embodiments of the method according to the invention of manufacturing an airbag module and the method of manufacturing webbing for a safety system in a vehicle are stated in the subclaims which can be combined optionally with each other.

In accordance with the invention, the object is achieved by a method of manufacturing an airbag module for a safety device in a vehicle, the airbag module comprising a module housing, an airbag introduced into the module housing, and a gas generator connected to the module housing. The method comprises the following steps of:
providing a multi-filament yarn by melt spinning;
weaving the multi-filament yarn to form a fabric and optionally brightening the fabric;
cutting the fabric into wall parts of an airbag and sewing the wall parts to form the airbag with a gas inlet opening;
introducing the airbag with the gas inlet opening into the module housing, and coupling the gas inlet opening to the gas generator to form the airbag module.

The multi-filament yarn is formed of at least one thermoplastic polymer that is manufactured partly or completely using recycled or renewable raw materials.

The invention also relates to a method of manufacturing webbing for a safety device in vehicles comprising the following steps of:
providing a multi-filament yarn by melt spinning a thermoplastic polymer; weaving the multi-filament yarn into a fabric strap and optionally scooping the fabric; and cutting the fabric strap to form a webbing of defined length.

In this case, too, the thermoplastic polymer which is used to manufacture the multi-filament yarn by melt spinning is manufactured completely or partly of recycled and/or renewable raw materials.

The webbing can preferably be coupled to a belt tensioner module which, in the case of accident, can be activated by mechanical, electromotive or pyrotechnical force and can act upon the webbing.

Resorting to recycled or renewable raw materials for the production of thermoplastic polymers and the subsequent processing thereof into multi-filament yarns enables fabric-based component parts of safety systems in vehicles to be manufactured sustainably and with reduced PCF. In this way, a substantial contribution to a climate-friendly manufacture of said component parts can be made without impairing safety-relevant characteristics of the products. Moreover, the dependence of the manufacture on fossil starting materials can be further reduced. Dispensing with fossil starting materials for the manufacture can also involve the reduction of energy-intensive chemical reactions and, thus, can contribute to designing the suggested method in a more resource-conserving, sustainable and environmentally friendly manner.

The invention is based on the finding that recycled and renewable materials are also suited for the manufacture of safety-relevant component parts in a vehicle. In view of the high requirements made to an airbag and/or a webbing, this is not self-evident. The inventors found that thermoplastic polymers of renewable and/or recycled materials can be integrated in the manufacture of webbings and airbag modules without impairing the safety-relevant characteristics of said component parts.

Basically, the invention is not restricted to a specific thermoplastic polymer, but any thermoplastic polymer known from prior art that is suitable as a component of a multi-filament yarn for an airbag or a webbing can be used.

According to one aspect, advantageously the thermoplastic polymer is made at least partly of a recycled polyester and/or a recycled polyamide. Optionally, the thermoplastic polymer can also contain a proportion of a petroleum-based polyester and/or a petroleum-based polyamide. In the following, petroleum-based is understood to be a polyester and/or a polyamide that is produced of non-recycled starting materials and raw materials which originate from crude oil or derivatives thereof.

According to another aspect, the thermoplastic polymer can also be made completely of a recycled polyester and/or a recycled polyamide.

Equally, the thermoplastic polymer can be made of a biobased polyester and/or a biobased polyamide, viz. of a polyester and/or a polyamide produced of renewable raw materials. Optionally, the thermoplastic polymer can also contain a proportion of a petroleum-based polyester and/or polyamide.

According to another aspect, the thermoplastic polymer can also be made completely of a biobased polyester and/or a biobased polyamide.

In addition, also a three-component composition of the thermoplastic polymer is conceivable, wherein the thermoplastic polymer comprises (A) a proportion consisting of a biobased polyester and/or a biobased polyamide, (B) a proportion consisting of a recycled polyester and/or a recycled polyamide, and (C) a proportion consisting of a petroleum-based polyester and/or a petroleum-based polyamide.

Advantageously, the three-component composition (A) comprises a biobased polyester and/or a biobased polyamide in a proportion from 5 to 90% by weight, (B) a recycled polyester and/or a recycled polyamide in a proportion from 5 to 90% by weight, and (C) a petroleum-based polyester and/or a petroleum-based polyamide in a proportion from 0 to 20% by weight, each based on the total weight of the thermoplastic polymer, the components (A) to (C) together amounting to 100% by weight.

The use of raw materials of different sources offers the advantage that the PCF of the thermoplastic polymer made therefrom can be adjusted as required. A higher proportion of recycled polyester and/or recycled polyamide and/or of biobased polyester and/or biobased polyamide reduces the PCF, while an increase in the proportion of petroleum-based polyester and/or petroleum-based polyamide results in an increase in PCF. The PCF of the thermoplastic polymer can be determined as above described.

Said polymers have been in use already to manufacture fabrics for airbags and/or seatbelts so that known specifications can be resorted to.

According to another aspect, the recycled polyester is selected from the group consisting of a recycled polyethylene terephthalate (PET), polyethylene terephthalate (PET) having a proportion of at least 30% by weight of renewable raw materials and a polyethylene terephthalate (PET) having a proportion of 100% by weight of renewable raw materials, and combinations thereof.

The recycled polyamide may be selected from the group consisting of polyamide 4.10, polyamide 4.6, polyamide 5.6, polyamide 5.10, polyamide 6, polyamide 6.10, polyamide 10.10, polyamide 10.12 and polyamide 11, as well as combinations thereof, hereinafter referred to as PA 4.10, PA 4.6, PA 5.6, PA 5.10, PA 6, PA 6.10, PA 10.10, PA 10.12 and PA 11.

The above-mentioned polyamides excel by a particularly high breaking strength and load-bearing capacity so that they are specifically suited as polymer materials for airbag fabrics and webbings.

The recycled polyamides are particularly thermoplastic polymers. Basically, the recycled raw materials are not restricted with respect to the thermoplastic polymers, and all known thermoplastic polymers can be used.

Advantageously, the recycled raw materials are obtained from basic raw materials which may originate from different sustainable sources. The basic raw materials advantageously originate from production waste, recycling systems and/or residual waste.

For example, industrial production waste and packaging waste such as from bottle return systems can be used. Almost unmixed basic raw materials can be obtained from said waste. However, it is also possible to use basic raw materials from tertiary waste such as domestic garbage from which plastic waste can be separated by mechanical and chemical methods.

The recycled raw materials can be obtained from the above-mentioned sources by mechanical recycling, specifically by removal of foreign matter.

Mechanical recycling is understood in the following to be a method of recycling basic raw materials, specifically plastics such as thermoplastic polymers in which the polymer structure is retained during the recycling process.

The mechanical recycling comprises at least one step selected from the group consisting of sorting, comminuting, washing, drying, post-polymerizing, for example via solid state polycondensation (SSP) and/or liquid state polycondensation (LSP), extruding and re-granulating.

Sorting of the basic raw materials to be recycled can be carried out either by the recycling system or by spectroscopic techniques such as near infrared spectroscopy (NIR). The spectroscopic examination of the basic raw materials in particular allows to separate the individual types of plastic from each other. Processes of inductive and magnetic metal separation, air separation and screening can assist the separation of the basic raw materials from each other. As required, the types of plastic separated from each other can be comminuted. The comminution is followed by the wet-mechanical preparation which is composed of a multi-stage washing and separating process. In this way, particularly foreign matter such as food residues, minerals and other organic residues can be removed. The individual types of target plastic can be separated from each other by means of their density in a basin or by sorting centrifuges. Similar methods of density separation are known from prior art and can also be used. In the case of similar density ranges of the plastics to be separated, the above-mentioned near infrared spectroscopy can be used for targeted differentiation. Subsequently, the plastics can be dried by mechanical and/or thermal processes. In particular vacuum drying is suited for this purpose. The unmixed recycled material obtained in this way can be completely melted subjected to pressure and temperature in an extruder. Finally, the melt is granulated and cooled.

Optionally, the thermoplastic polymers can also be dissolved in an appropriate solvent and can be freed from impurities, with the molecular structure of the polymers being maintained. By specific solvents adapted to the respective plastic material the latter can be solubilized, with the polymer structure being maintained. The residue obtained in this way can be removed by filtration, for example. The solubilized plastic material can be precipitated after separation, the solvent can be removed and the plastic material can be dried. The plastics obtained in this way then can be granulated in an extruder.

The use of solvents offers the advantage that even strongly polluted plastic waste can be recycled in high quality. In this way, impurities which are otherwise difficult to separate from the plastic material can be removed, as they do not dissolve in the solvent. Also, multi-layer plastic laminates can be separated. The selection of the suitable solvent depends on the plastic material to be recycled.

Another option of filtration and recycling of thermoplastic polymers is offered by melt filtration. Accordingly, the basic raw material to be recycled is melted and the melt forming is filtered through an appropriate filter element, where impurities are withheld. The filter element can particularly be a metallic porous filtering insert.

Melt filtration offers the technical advantage that impurities can be removed even without the use of solvents to ensure the desired purity of the polymers.

The mechanical recycling is particularly suited for the treatment of thermoplastic polymers of industrial production waste and of packaging waste. Mechanical recycling offers the advantage of the recycling operation per se involving a low treatment effort. However, this is linked to an appropriate quality of the input materials which is specifically ensured by the initial sorting.

For treating more strongly polluted waste, also feedstock or chemical recycling processes can be used in which the polymers are depolymerized using thermochemical or wet-chemical processes and are broken down into their basic monomers or other basic materials. The chemical recycling comprises at least one step from the group consisting of depolymerizing, purifying, polymerizing and re-granulating.

Particularly suited are solvolysis methods where the polymers are converted to aqueous or organic solutions by suitable reagents such as acids, bases, alcohols and amines, optionally at increased temperature and pressure. The polymers are disintegrated into their basic monomers or derivatives thereof which then can be separated from the reaction mixture and can be separately purified. Subsequently, they can be converted into the desired polymers by polymerization.

The renewable raw materials advantageously are monomers obtained from biomass. In the following, they are referred to as biobased monomers.

Basically, the selection of the biobased monomer is not limited, and any known biobased monomer can be used that can be made from biomass and is suited for the polymerization to form thermoplastic polymers. A thermoplastic polymer prepared completely or partly using biobased monomers consequently is a biobased thermoplastic polymer. The use of biomass to prepare those polymers offers the advantage that the biomass is available as required, renewable and sustainable on suitable growing conditions.

In an advantageous embodiment, the biobased monomers are selected from the group consisting of aliphatic polycarbonic acids, aliphatic polyamines, terephthalic acid, isophthalic acid and aliphatic polyols, specifically monoethylene glycol, as well as combinations thereof.

Further biobased monomers which can be obtained from renewable raw materials are succinic acid of glucose by fermentation, valeric acid obtained from the hydrolysis step of biogas plants, pimelic acid of castor oil, azelaic acid of oleic acid obtained by oxidative conversion and dodecanoic di-acid of coconut oil or palm kernel oil and fermentation of capric acid. On the basis of said monomers, the appropriate diols and/or diamines can be obtained by biotechnological processes and optionally further chemical reaction.

In particular sugar-containing plants, starch-containing plants, lignocellulose and/or agricultural waste are suited as biomass. Those plants are particularly suited as they have a very high proportion of glycosidically linked structural sugar elements such as starch.

Examples of suitable plants are potatoes, sugar beet, wheat and corn.

Oil fruits including oilseeds and oleiferous plants and plant parts are also suited.

For example, seeds of the castor oil plant are suitable as oil fruits.

Advantageously, the basic raw materials polysaccharide, in particular sugar and starch, lignin, cellulose and/or vegetable oil, in particular castor oil, can be obtained from the biomass, optionally using fermentation and/or catalytic processes. More precisely, the starch contained in the biomass can be converted into sugar. Sugar is understood to be particularly all types of pentoses such as ribose, arabinose and xylose, hexoses such as fructose, glucose, mannose, galactose, fucose and rhamnose, as well as derivatives thereof such as derived amines, amides, esters and deoxygenated compounds.

The basic raw materials in question here can be used for preparing the biobased monomers.

The steps for preparing the thermoplastic biobased polymers of renewable raw materials comprise particularly the formation of biobased monomers from biomass by oxidation or reduction, fermentation, chemical conversion and/or hydrolysis, as well as polymerization of the monomers and granulation of the polymers prepared therefrom.

In this way, for example the alcohols and dicarboxylic acids required to prepare polyesters and the dicarboxylic acids and diamino compounds and/or amino-substituted carboxylic acids or lactones used to prepare polyamides can be obtained.

According to another aspect, the thermoplastic polymer is intended to be the biobased polymer PA 5.6 that is provided by the following steps of:
hydrolysis of biomass to obtain a sugar and starch mixture;
bacterial fermentation of the sugar and starch mixture to form 1,5-diaminopentane;
yeast-fermentation of the sugar and starch mixture to form 1,6-hexanedioic acid; and
poly-condensation of 1,5-diaminopentane and 1,6-hexanedioic acid to obtain the thermoplastic biobased polymer PA 5.6.

According to another aspect, the thermoplastic polymer is the biobased polymer PA 4.10 that is provided by the following steps of:
pressing of biomass to obtain press residue and vegetable oil;
fermentation of the press residue and/or the biomass to form 1,4-butane diamine; basic hydrolysis of vegetable oil to obtain 1,8-octane dicarboxylic acid; and
poly-condensation of 1,8-octane dicarboxylic acid and 1,4-butane diamine to obtain the thermoplastic biobased polymer PA 4.10.

In this way, the polyamide 4.10 can be prepared directly from biomass without the use of feedstock of fossil raw materials. The polyamide 4.10 prepared in this manner is particularly suited for use as multi-filament yarn in airbags or in webbings.

In another aspect, the thermoplastic polymer is BioPET100% that is provided by the following steps of:
hydrolysis of biomass to obtain a sugar and starch mixture;
fermentation of the sugar and starch mixture to form bioethanol;
dehydration of bioethanol to obtain ethylene;
oxidation of ethylene with oxygen to obtain ethylene oxide;
hydrolysis of ethylene oxide to obtain monoethylene glycol;
optionally a) acid-catalyzed dehydration of sugars into (hydroxymethyl) furfural (HMF) followed by hydrogenation thereof into 2,5-dimethylfurane; adding 2,5-dimethylfurane to ethylene and subsequent dehydration to obtain p-xylene;
or b) catalytic hydration of hydrolyzed biomass to obtain deoxygenated feedstock which is subsequently converted into p-xylene by a refinery process;
catalytic oxidation of p-xylene into terephthalic acid; and
poly-condensation of monoethylene glycol and terephthalic acid to obtain the thermoplastic polymer BioPET100%.

The thermoplastic polymer BioPET100% obtained in this way consists substantially, viz. fully, of renewable raw materials, i.e., monoethylene glycol and terephthalic acid. BioPET100% can also be used directly in the manufacture of airbag modules and webbings.

The thermoplastic polymer can also be BioPET30% in which biobased monoethylene glycol and terephthalic acid conventionally produced of petroleum-based raw materials are provided and, in a subsequent step, react with each other in a polycondensation to obtain BioPET30%.

The term BioPET30% is only the trivial name of the thermoplastic PET polymer obtained. Due to the stoichiometry of the polycondensation, the biobased monoethylene glycol is present in the PET polymer in a proportion of 31.2% by weight and the terephthalic acid is present in a proportion of 68.8% by weight.

For preparing biobased monoethylene glycol, the same process can be used as already described above for BioPET100%.

To produce terephthalic acid from crude oil is known already from prior art. For example, naphtha (raw gasoline) can be obtained as feedstock from crude oil by fractional distillation. P-xylene which can be separated again by fractional distillation can be obtained by steam-cracking of naphtha. Targeted oxidation of p-xylene results in the desired terephthalic acid. For example, p-xylene can react to form terephthalic acid by air oxidation and in the presence of a cobalt-based catalyst.

The monomers of renewable raw materials obtained in this way can also react to form polyamides by polycondensation. Polycondensation reactions between aliphatic polyamides and aliphatic dicarboxylic acids to form polyamides are sufficiently known.

In general, the biobased polymers and the recycled polymers can further be post-polymerized to reach a degree of polymerization suitable for an intended use.

The recycled and biobased polymers produced by the above-described method, in particular polyamides and polyesters, can be used as basic polymers in the manufacture of airbag modules and webbings.

Melt spinning of the basic polymers obtained in this way is carried out in accordance with known technical processes of yarn production as described, for example, in Ulmann Encyclopedia of Industrial Chemistry, vol. 13, p. 465 seq. (2003).

Multi-filament yarns which are produced completely or partly of recycled or renewable raw materials are obtained in this way.

In one aspect, the multi-filament yarn used in a method according to the invention is made of PA 6.6 and has a thread count of 235 to 700 dtex, preferably 350 to 700 dtex, a breaking strength ranging from 20 to 60 N and an elongation at break ranging from 15 to 25%.

In another aspect, the multi-filament yarn used in a method according to the invention is made of PET and has a thread count of 470 to 555 dtex, a breaking strength ranging from 35 to 40 N and an elongation at break ranging from 15 to 30%.

### EXAMPLES

In the following, two examples of multi-filament yarns are given which can be used in the methods according to the invention.

In a first example, there was produced a biobased polyamide 5.6, hereinafter referred to as PA 5.6.

For producing the biobased polyamide 5.6, in a first step biomass in the form of plant waste was provided. The biomass was then hydrolyzed to obtain a sugar-starch mixture. Said mixture was subsequently fermented to form 1,5-diaminopentane. In addition, adipic acid was obtained from a crude oil raffinate by means of oxidative reaction. A subsequent polycondensation of 1,5-diaminopentane and adipic acid results in the biobased PA 5.6.

By means of melt spinning, the obtained PA 5.6 was processed into filaments from which the multi-filament yarn was formed.

Each of the obtained multi-filament yarns of biobased PA 5.6 has a filament number of f96. The breaking strength and the elongation at break were determined according to the ISO 13934-1 standard and the thread count was determined according to the ISO 1144 standard (Table 1).

What is characteristic of the use in an airbag fabric or in a webbing is the thread count as well as the fabric design and the resulting breaking strength/elongation at break. The characteristic values stated in Table 1 such as thread count, tear strength, breaking strength and elongation at break of PA 5.6 are comparable to those of a yarn that was made of petroleum-based raw materials.

TABLE 1

| | PA 5.6 |
|---|---|
| | (biobased) |
| | [470dtex/96f] |
| Thread count (dtex) | 470-485 |
| Tear strength (cN/dtex) | ≥7.5 |
| Breaking strength (N) | ≥36 |
| Elongation at break (%) | 22-27 |

In a second example, a multi-filament yarn was produced of recycled PET. The PET required for producing the multi-filament yarn was recycled by means of a mechanical recycling process so that the polymer structure was not changed. PET bottles were used as feedstock for the multi-filament yarn.

In a first step, PET drink bottles from a collecting system were freed from films, metals and other plastics, were sorted and then mechanically comminuted into flakes. A hot washing process with subsequent vacuum drying followed. The flakes obtained were re-sorted once again and then re-granulated. The re-granulate was finally spun in a melt spinning process to form a multi-filament yarn.

The yarn obtained in this way has a filament number of f96. The breaking strength and the elongation at break were determined according to the ISO 13934-1 standard, and the thread count was determined according to the ISO 1144 standard (Table 2).

What is characteristic of the use in an airbag fabric or in a webbing is the thread count as well as the fabric design and the resulting breaking strength and elongation at break. The multi-filament yarn should have approximately the same properties as a yarn based on non-recycled raw materials.

In Table 2, two multi-filament yarns (recycled) which were produced of recycled PET bottles according to the above methods are compared to two multi-filament yarns (standard) which were produced of non-recycled basic raw materials.

The multi-filament yarn (recycled) having a thread count of 470 dtex and a filament number of 96f exhibits the same properties as a multi-filament yarn made of non-recycled basic raw materials spun with comparable thread count and the same filament number. Also, the multi-filament yarn having a thread count of 555 dtex and a filament number of 96f exhibits the same properties as a multi-filament yarn made of non-recycled basic raw materials spun with a comparable thread count and the same filament number.

TABLE 2

| | PET | PET | PET | PET |
|---|---|---|---|---|
| PET polymer | (standard) | (recycled) | (standard) | (recycled) |
| Filament number | 96 | 96 | 96 | 96 |
| Thread count (dtex) | 467 | 466 | 557 | 553 |
| Breaking strength (N) | 34.3 | 32.3 | 44 | 38 |
| Tensile strength | 7.3 | 6.9 | 7.9 | 6.9 |
| (cN/dtex) | | | | |
| Elongation at break (%) | 22.2 | 20.8 | 18.5 | 21.8 |
| Hot air shrinkage (%) | 4.1 | 6.1 | 5.7 | 5.9 |
| [180° C./15 min] | | | | |

### DESCRIPTION OF FIGURES

In the following, the invention will be described in detail based on embodiments with reference to the attached drawings which are not to be understood in a limiting sense, and wherein:

FIG. 1 shows a schematic cycle of the steps of a method of manufacturing an airbag module and a webbing according to the invention;

FIG. 2 shows a schematic cycle of the steps of a method of manufacturing biobased PA 5.6;

FIG. 3 shows a schematic cycle of the steps of a method of manufacturing biobased PA 4.10; and

FIG. 4 shows a schematic cycle of the steps of a method of manufacturing BioPET100%.

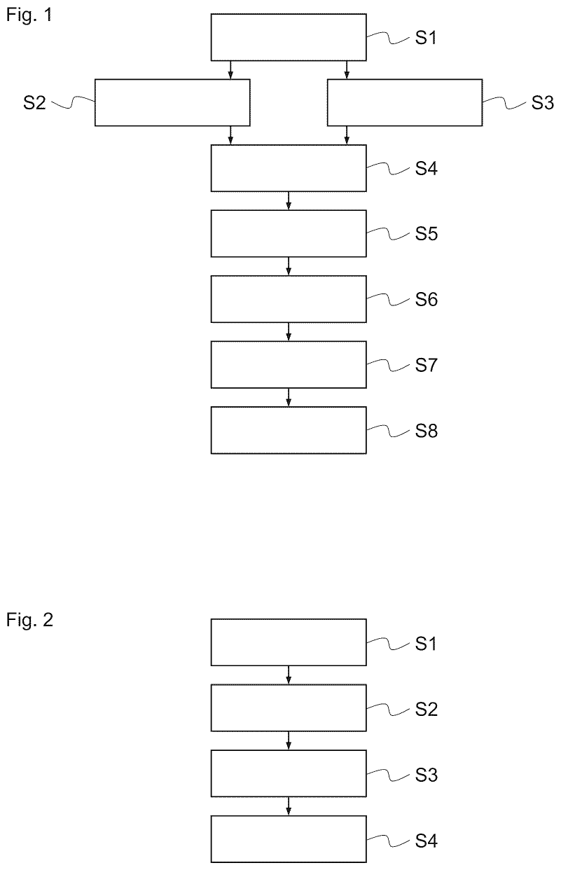

FIG. 1 illustrates a schematic cycle of the steps of a method of manufacturing airbag modules and webbings according to the invention.

In a first step, the basic raw materials are provided (S1).

The basic raw materials can be either raw materials to be recycled or biomass.

The raw materials to be recycled originate particularly from primary, secondary and/or tertiary recycling. Primary recycling comprises the use of basic raw materials of production waste, secondary recycling comprises the use of basic raw materials from recycling systems, and tertiary recycling makes use of basic raw materials from other waste, specifically from residual waste that is difficult to recycle such as domestic waste, bulky waste, electronics waste, post-consumer textiles, waste from recovering measures from dumping grounds or waste recovered from waters or industrial residues, for example from agricultural and/or construction industry.

In particular, plants and plant residues containing sugar and starch as well as oleiferous plants can be used as biomass. Consequently, almost each part of a plant can be used. Particularly the exploitation of agricultural waste is of advantage as a land use competing against the food production is avoided.

In the next step, the basic raw materials are treated (S2). The raw materials to be recycled are fed either to the mechanical recycling or to the chemical recycling.

The mechanical recycling is specifically divided once more into the sub-steps of sorting, comminuting, optionally a first extrusion of a granulate, optionally a subsequent post-polymerization, optionally a second extrusion, a hot-washing, a drying, a quality control and a re-granulating by extrusion.

Also, melt filtering of the basic raw materials can be carried out as mechanical recycling.

Melt filtering of the basic raw materials can also be used in addition to the purification of the recycled raw materials.

Chemical recycling comprises specifically the sub-steps of sorting, depolymerizing, purifying, polymerizing and re-granulating.

Following the mechanical recycling or chemical recycling, a recycled thermoplastic polymer is obtained.

Advantageously, the mechanical recycling or the chemical recycling is carried out so that a polyamide or a polyester is obtained.

The biomass provided is processed in a separate step, however, to obtain a thermoplastic polymer from renewable raw materials (S3).

The oil contained in the biomass or the starch contained in the biomass is first solubilized and separated from the remaining biological components. The processing of the biomass can be subdivided into the sub-steps of hydrolysis, fermentation and/or one or more chemical reactions, polymerization and granulation.

In the next step, the thermoplastic polymers of step 2 (S2) and step 3 (S3) can be combined again and processed to form a yarn (S4). Producing the yarn is divided into the sub-steps of melt spinning, drawing and stretching of the spun threads to the desired length and thickness, cooling of the stretched threads, connecting the individual filaments to form a multi-filament yarn, and winding the multi-filament yarn obtained in this way onto a reel.

The individual filaments can be connected, as required, to form multi-filament yarns of different numbers of filaments and/or different thread counts. In particular, other yarn counts and filament numbers are preferred for multi-filament yarns made of PET than for multi-filament yarns made of PA, and vice versa. Table 3 provides a survey of preferred yarn counts for multi-filament yarns depending on the thermoplastic polymer used.

TABLE 3

| | |
|---|---|
| PA | PET |

| | |
|---|---|
| Yarn count | Number of Filaments |

| | | |
|---|---|---|
| 235 dtex | 72 | — |
| 350 dtex | 140 | — |
| 470 dtex | 140 | 96 |
| 555 dtex | — | 96 |
| 580 dtex | 140 | — |
| 700 dtex | 105 | — |

The multi-filament yarn produced in this way can be reworked for the later weaving procedure, for example by applying a protective layer or facing (S5). This can be done in particular by brightening the multi-filament yarn.

Now the multi-filament yarn is woven into a fabric or a fabric strap and the fabric is optionally brightened (S6). Weaving can be subdivided once more into the sub-steps of weaving, washing, drying and optionally brightening the fabric obtained.

After that, the fabric is cut into wall parts of an airbag and the wall parts are sewn to form the airbag with a gas inlet opening (S7). The fabric strap can also be cut to form a webbing, for example by cutting the fabric strap to the desired length.

In the last step, the airbag is mounted into the module housing to obtain an airbag module, and the webbing is mounted into the belt retractor housing to obtain a belt retractor module (S8).

FIG. 2 illustrates a schematic cycle of the steps of a method of producing polyamide 5.6 for a multi-filament yarn for use in an airbag or a webbing.

In a first step, biomass is provided (S1). The biomass can be, as already described above, plants containing starch and/or sugar.

In the next step, the hydrolysis is carried out, usually acid-catalyzed, under increased pressure and at increased temperature of the provided biomass to obtain a sugar-starch mixture (S2).

Hereinafter, a sugar-starch mixture is understood to be a sugar-starch solution, a sugar-starch suspension or other starch- and sugar-containing compositions which can be produced from biomass.

In another step, the mixture obtained in this way can be processed in separate reaction steps by fermentation with different microorganisms and/or enzymes (S3). This is done in each case to form the intermediate products 1,5-diaminopentane and/or adipic acid. The former results in particular from bacterial fermentation, while the latter results particularly from yeast fermentation. The biotechnological production of adipic acid can also comprise the fermentation into muconic acid or glucaric acid which by subsequent hydrogenation are converted into adipic acid (indirect fermentation).

In particular, recombinant strains of the Corynebacterium glutamicum or Escherichia coli bacteria and of the Saccharomyces cerevisiae yeast are used for the fermentation.

In a last step, the intermediate products obtained are reacted in a polycondensation reaction to obtain the desired polyamide 5.6 (S4). For the polycondensation, there is particularly preferred a two-stage reaction via the intermediately formed stoichiometric amino carboxylate, as this guarantees an ideal proportion of the monomers in order to achieve a high degree of polymerization.

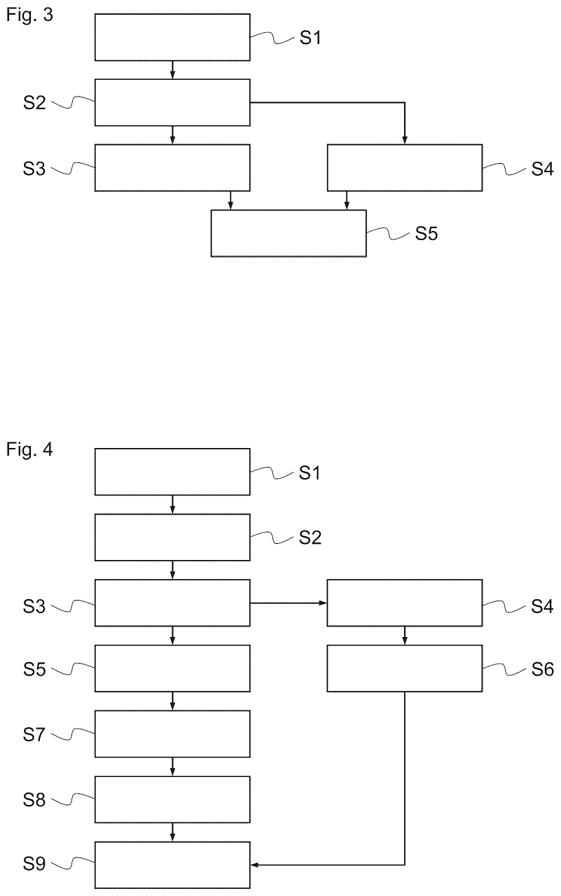

FIG. 3 illustrates a schematic cycle of the steps of a method of producing the polyamide 4.10 for a multi-filament yarn for use in an airbag or a webbing.

In a first step, biomass is provided (S1).

In particular, in this method oleiferous plants and/or plant residues are used. For example, oilseeds of the castor plant can be used for the procedure.

In the next step, the biomass is pressed to obtain vegetable oil and plant residue (S2). After that, the latter are separated from each other.

The intermediate product 1,8-octanediolic carboxylic acid is obtained from the vegetable oil by basic hydrolysis (S3).

Next, plant residues and/or biomass are fed to bacterial fermentation so as to obtain the intermediate product 1,4 butane diamine (S4).

Subsequently, the two intermediate products are reacted with each other in a polycondensation reaction to obtain the desired polyamide 4.10 (S5).

FIG. 4 illustrates a schematic cycle of the steps of a method of producing BioPET100% for a multi-filament yarn for use in an airbag or a webbing.

In a first step, again biomass containing starch and sugar is provided (S1).

In the next step, the hydrolysis of the biomass is carried out to obtain a sugar-starch mixture (S2).

The sugar-starch mixture obtained in this way is fermented and subjected to further chemical reactions in the next step to obtain the intermediates bioethanol and 2,5-dimethylfurane (S3). After that, 2,5-dimethylfurane is converted into p-xylene. The processing of the sugar-starch mixture to form p-xylene can be carried out by means of two routes of synthesis.

In a first alternative, 2,5-dimethylfurane can be obtained by an acid-catalyzed dehydrogenation of sugars into (hydroxymethyl) furfural (HMF) as well as the subsequent hydrogenolysis thereof. After that, adding of 2,5-dimethylfurane to ethylene and subsequent dehydration can be carried out to obtain p-xylene (S4). Advantageously, a part of the ethylene obtained by step S5 can be used for this purpose.

According to a second alternative, a catalytic hydrogenation of hydrolyzed biomass can be carried out to obtain deoxygenated starting material, the deoxygenated starting material being subsequently converted into p-xylene by a refining process (S4). For this purpose, a refining process known from prior art can be used.

Bioethanol is obtained by fermentation of the sugar-starch mixture. To this end, the sugar-starch mixture is mixed with various microorganisms and/or enzymes. For example, the Saccharomyces cerevisiae yeast can be used to produce bioethanol.

Subsequently, p-xylene is converted into the intermediate product terephthalic acid by a chemical reaction (S6). This can be carried out, inter alia, by air oxidation of p-xylene in the presence of a cobalt-based catalyst.

Bioethanol is converted, in the next step, into ethylene by a dehydration (S5).

The ethylene obtained is converted, in the next step, into ethylene oxide by an oxidation (S7).

Afterwards, ethylene oxide is hydrolyzed to obtain the intermediate product monoethylene glycol (S8).

In the last step, the intermediate products monoethylene glycol and terephthalic acid are reacted with each other to form BioPET100% in a polycondensation reaction.

1. A method of manufacturing an airbag module for a safety device in vehicles, the airbag module comprising a module housing, an airbag introduced into the module housing and a gas generator connected to the module housing, the method comprising the steps of:
providing a multi-filament yarn by melt spinning;
weaving the multi-filament yarn to form a fabric and optionally brightening the fabric;
cutting the fabric into wall parts of an airbag and sewing the wall parts to form the airbag with a gas inlet opening;
introducing the airbag with the gas inlet opening into the module housing, and
coupling the gas inlet opening to the gas generator to form the airbag module,
wherein the multi-filament yarn is formed at least of a thermoplastic polymer that is produced partly or completely using recycled and/or renewable raw materials.

2. A method of manufacturing a webbing for a safety device in vehicles, the method comprising the steps of:
providing a multi-filament yarn by melt spinning a thermoplastic polymer;
weaving the multi-filament yarn to form a fabric strap and optionally brightening the fabric; and
cutting the fabric strap to form a webbing having a defined length,
wherein the multi-filament yarn is formed at least of a thermoplastic polymer that is produced partly or completely using recycled and/or renewable raw materials.

3. The method according to claim 2, wherein the webbing is coupled to a belt tensioner module which is arranged, in the case of accident, to be activated by mechanical, electromotive or pyrotechnical force and to act upon the webbing.

4. The method according to claim 1, wherein the thermoplastic polymer is formed of a polyester and/or a polyamide, the polyester and/or the polyamide being selected from the group consisting of a recycled polyester and/or a recycled polyamide, a biobased polyester and/or a biobased polyamide, and a petroleum-based polyester and/or a petroleum-based polyamide, as well as combinations thereof.

5. The method according to claim 1, wherein the polyester is selected from the group consisting of a recycled polyethylene terephthalate (PET), a biobased polyethylene terephthalate (PET) having a proportion of at least 30% by weight of monomers of renewable raw materials and a biobased polyethylene terephthalate (PET) having a proportion of 100% by weight of monomers of renewable raw materials, as well as combinations thereof.

6. The method according to claim 4, wherein the recycled polyamide is selected from the group consisting of PA 4.10, PA 4.6, PA 5.6, PA 5.10, PA 6, PA 6.10, PA 10.10, PA 10.12 and PA 11, as well as combinations thereof.

7. The method according to claim 1, wherein the recycled raw materials are obtained from basic raw materials which originate from production wastes, recycling systems and/or residual wastes.

8. The method according to claim 7, wherein the recycled raw materials are obtained by mechanical recycling of the basic raw materials.

9. The method according to claim 8, wherein the mechanical recycling comprises at least one step from the group consisting of sorting, comminuting, washing, drying, post-polymerizing, extruding and re-granulating.

10. The method according to claim 8, wherein the recycled raw materials can be purified from the basic raw materials by means of melt filtration, the melt filtration comprising the steps of melting the basic raw materials to obtain a basic raw material melt and subsequent filtration of the basic raw material melt through a filter element to separate impurities and to obtain a recycled raw material.

11. The method according to claim 7, wherein the recycled raw materials are obtained from the basic raw materials by chemical recycling.

12. The method according to claim 11, wherein the chemical recycling is a solvation process, the solvation process comprising at least one step from the group consisting of depolymerizing, purifying, polymerizing and re-granulating.

13. The method according to claim 1, wherein the renewable raw materials are monomers obtained from biomass which are selected from the group consisting of aliphatic polycarboxylic acids, aliphatic polyamines, terephthalic acid and aliphatic polyols, particularly monoethylene glycol, as well as combinations thereof.

14. The method according to claim 13, wherein the biomass is selected from the group consisting of sugar-containing plants, starch-containing plants, oleiferous plants and agricultural wastes, as well as combinations thereof.

15. The method according to claim 13, wherein the basic raw materials used to produce the monomers originate from the biomass, and wherein the basic raw materials are selected from the group consisting of sugar, polysaccharides, specifically starch and/or cellulose, lignin, vegetable oil, specifically castor oil, as well as combinations thereof.

16. The method according to claim 1, wherein the thermoplastic polymer is biobased PA 5.6 that is provided by the following step of:
hydrolysis of biomass to obtain a sugar- and starch-containing mixture;
bacterial fermentation of the sugar- and starch-containing mixture to form 1,5-diaminopentane;
yeast fermentation of the sugar- and starch-containing mixture to form 1,6-hexanedioic acid; and
polycondensation of 1,5-diaminopentane and 1,6-hexanedioic acid to obtain the thermoplastic polymer PA 5.6.

17. The method according to claim 1, wherein the thermoplastic polymer is biobased PA 4.10 that is provided by the following steps of:
pressing of biomass to obtain press residue and vegetable oil;
fermentation of the press residue and/or a biomass to form 1,4-butane diamine;
basic hydrolysis of vegetable oil to obtain 1,8-octane dicarboxylic acid, and
poly-condensation of 1,8-octane dicarboxylic acid and 1,4-butane diamine to obtain the thermoplastic polymer PA 4.10.

18. The method according to claim 1, wherein the thermoplastic polymer is BioPET100% that is provided by the following steps of:
hydrolysis of biomass to obtain a sugar and starch-containing mixture;
fermentation of the sugar and starch-containing mixture to form bioethanol;
dehydration of bioethanol to obtain ethylene;
oxidation of ethylene with oxygen to obtain ethylene oxide;
hydrolysis of ethylene oxide to obtain monoethylene glycol;
optionally a) acid-catalyzed dehydration of sugars into (hydroxymethyl)furfural (HMF), followed by the hydrogenolysis thereof into 2,5-dimethylfurane, addition of 2,5-dimethylfurane to ethylene and subsequent dehydration to obtain p-xylene;
or b) catalytic hydrogenation of hydrolyzed biomass to obtain deoxygenated starting material that is subsequently converted into p-xylene by a refining step;
catalytic oxidation of p-xylene into terephthalic acid; and
poly-condensation of monoethylene glycol and terephthalic acid to obtain the thermoplastic polymer BioPET100%.

19. The method according to claim 1, wherein the thermoplastic polymer is BioPET30% in which monoethylene glycol produced from biomass and petroleum-based terephthalic acid are reacted with each other in a poly-condensation to obtain BioPET30%.
